(19) United States
(12) Patent Application Publication
(10) Pub. No.: US 2010/0203480 A1
(43) Pub. Date: Aug. 12, 2010

(54) DENTAL CROWN SHELL AND METHOD OF USE

(76) Inventors: Dean Schweitzer, Valencia, CA (US); Mark L. Worthington, Springfield, OR (US)

Correspondence Address: KLARQUIST SPARKMAN, LLP, 121 SW SALMON STREET, SUITE 1600, PORTLAND, OR, 97204, US

(21) Appl. No.: 12/701,345

(22) Filed: Feb. 5, 2010

Related U.S. Application Data
(60) Provisional application No. 61/206,999, filed on Feb. 6, 2009.

(51) Int. Cl. A61C 5/10

(52) U.S. Cl. 433/223

(57) ABSTRACT

A dental crown shell is disclosed, as well as a method of preparing the crown by in-situ polymerization of resin within a thin shell that undergoes an exothermic reaction that releases sufficient heat to bond the resin to the shell and form a durable crown for placement in the mouth of a patient.

### CROSS REFERENCE TO RELATED APPLICATION

This application claims the benefit of U.S. Provisional Application No. 61/206,999, filed on Feb. 6, 2009, which is incorporated herein by reference in its entirety.

### FIELD OF THE DISCLOSURE

Disclosed herein is a mold for a temporary or provisional crown, and more particularly a flexible crown shell and methods of using that crown shell to make a temporary or longer term dental crown in pediatric patients.

### BACKGROUND

When the crown of a tooth has been damaged, dentists must often fabricate an artificial replacement crown to avoid further damage to the tooth. The cracked tooth is “prepared” for the crown by grinding the damaged tooth down to about the cemento-enamel junction (CEJ) and placing a temporary replacement crown over the prepared tooth stump. Placement of the temporary crown allows the careful subsequent laboratory fabrication of a permanent crown. The temporary crown can then be removed and replaced by the permanent crown.

Three primary methods have been used to fabricate temporary or provisional crowns for placement on a prepared tooth stump. In one method, a conventional prefabricated crown form or shell (typically made of aluminum, stainless steel or polycarbonate) is trimmed and shaped to fit the prepared tooth. The shell is then filled with a temporary resin or other composition, which is allowed to harden in situ so that the resin conforms to the shell and binds to it. The shell and hardened composition are then removed from the tooth, shaped and ground to adjust their shape, and temporarily sealed on the prepared tooth stump. Examples of temporary crowns of this type are disclosed in U.S. Pat. No. 4,015,332 (Manne), U.S. Pat. No. 4,678,435 (Long), U.S. Pat. No. 4,778,386 (Spiry), and U.S. Pat. No. 5,458,489 (Tennyson). In the Spiry patent, the top of the shell is completely open so that the resin can be introduced into the shell through that opening.

In an alternative technique, an impression is made of the tooth before the tooth is ground down to be prepared for a crown. After the impression is made, the tooth is prepared and the impression, filled with a bis-acryl material, and is placed over the prepared tooth. After the bis-acryl material sets, it is removed from the dental impression, and then trimmed, polished, and seated in the mouth.

In yet another technique, a putty-like ball of polymethyl-methacrylate is applied over a prepared tooth. The patient then bites down to form a rudimentary crown shape as the material begins to set. Before it completely sets, the putty-like material is removed from the tooth, trimmed and placed back on the tooth to finish hardening. Once the material sets, it is trimmed again and the bite adjusted. Finally, the temporary crown is cemented to the tooth. A variation of this technique is disclosed in U.S. Pat. No. 5,385,469 in which a tubular dental form is used to form a universal crown.

Each of these techniques has advantages and disadvantages. Using prefabricated forms is generally considered to be fast and simple, but the fit of the conventional shell is often not optimal. The margins of the form may not fit well, which makes it difficult to obtain good proximal contact to adjacent teeth, and the contours and occlusion are not always acceptable. The temporary crown may have to be repeatedly removed, re-shaped and replaced on the prepared stump until it has assumed the correct shape, particularly on its occlusal surface that abuts teeth from the opposing dental arch. Unfortunately, the fabrication of crowns in this fashion is time-consuming, which can reduce the efficiency and increase the cost of dental care.

Efforts have been made to increase the efficiency of temporary crown placement by providing different sized shells for in situ fabrication of temporary dental crowns, as shown in U.S. Pat. Nos. 6,068,481 and 6,257,892. The shells in these patents have windows in the mesio-distal walls to allow resin to flow out of the shell and contact proximal teeth. U.S. Patent Publication 2005/0244770 discloses a dental crown shell having an occlusal opening to extrude resin on to the occlusal surface of the crown shell during crown placement.

However, none of these systems is designed for use in pediatric patients. In the past, pediatric dental crowns have often been made of unsightly stainless steel material, such as the crown shells in U.S. Pat. No. 7,008,229 which provides an aesthetically unpleasing result. To improve the appearance of stainless steel crowns, the stainless steel material has been covered by a resin veneer or coating having a tooth-like appearance. However these resin surfaces are prone to cracking or chipping under normal use. U.S. Patent Publication 2006/0154211 discloses a pediatric dental crown method in which a crown form is imbedded into a holding agent, and a hardening agent is then poured over the surfaces of the crown form.

Another choice for prefabricated pediatric crowns is strip crowns. Strip crowns are prefabricated clear plastic crown shells. The crown shell is filled with a resinous material, placed on a prepared tooth, and the resinous material is light cured to harden it. The shell may either be removed or remain permanently attached to the resin filler. Although the resulting crown has a pleasing appearance, the plastic crowns commonly fracture and/or break under normal occlusion.

### SUMMARY OF THE DISCLOSURE

The foregoing problems are addressed by the crown shell and method disclosed herein.

In one embodiment, a method of making a dental crown for a tooth is provided. The method includes providing a flexible crown shell formed of a resinous material and having a thickness of about 0.0015 inches or less. The crown shell has a closed upper face, closed side walls, and an open bottom face. The crown shell is inverted so that the open bottom face is directed upwardly. A mixture of an adhesive powder and an adhesive liquid is introduced into the crown shell through the open bottom face. The crown shell is positioned on a tooth by introducing the tooth through the open bottom face of the crown shell. The mixture is allowed to cure until an internal cavity is formed within the shell with a shape that is substantially complementary to the tooth. The crown shell is removed from the tooth. A cement is provided between the tooth and the cured mixture to secure the crown shell to the tooth.

In specific implementations, the introduction of the mixture into the crown shell causes an exothermic reaction that bonds the mixture to an interior surface of the crown shell. In other specific implementations, the crown shell has a thickness of about 0.0013 inches or less.

In specific implementations, the introduction of the mixture includes introducing the adhesive powder into the crown shell through the open bottom face, introducing the adhesive liquid into the crown shell through the open bottom face to saturate the adhesive powder, adding additional adhesive powder to substantially fill the crown shell, and mixing the adhesive powder and adhesive liquid in the crown shell to produce the mixture.

In specific implementations, the crown shell is a polycarbonate material, and the adhesive powder and adhesive liquid are methyl methacrylate. In other specific implementations, the adhesive powder is F-88 adhesive powder and the adhesive liquid is F-88 adhesive liquid. In certain implementations, the tooth comprises a tooth of a pediatric patient and the securing of the crown shell to the tooth is permanent.

In another embodiment, a kit for preparing a dental crown for a tooth is provided. The kit comprises a flexible shell formed of a resinous material, and an adhesive powder and an adhesive liquid that can be mixed together to cause an exothermic reaction. The flexible shell has a thickness of about 0.0015 inches or less, and has a closed upper face, closed side walls, and an open bottom face.

In specific implementations, the flexible shell has a thickness of about 0.0013 inches or less. In other specific implementations, the flexible shell is made of bisphenol A polycarbonate and is generally translucent.

In other specific implementations, the adhesive powder and adhesive liquid comprise methyl methacrylate. The adhesive powder can be F-88 adhesive powder and the adhesive liquid can be F-88 adhesive liquid. A mixture of the adhesive powder and the adhesive liquid can provide a tensile shear strength of about 1500 psi or greater when cured.

In other specific implementations, the kit can include a plurality of flexible shells of different shapes and sizes. The plurality of flexible shells can be configured to substantially anatomically match the exterior shape of a tooth.

In another embodiment, a dental crown is provided. The dental crown includes a generally translucent, flexible shell formed of a resinous material that has a thickness of about 0.0015 inches or less. The flexible shell has a closed upper face, closed side walls, and an open bottom face. The open bottom face is sized to receive a tooth and the exterior shape of the closed upper face and side walls are substantially shaped to match the exterior shape of a tooth.

In specific implementations, the flexible shell has a thickness of about 0.0013 inches or less. In other specific implementations, the flexible shell can be made of bisphenol A polycarbonate.

### BRIEF DESCRIPTION OF THE DRAWINGS

FIG. 1 illustrates an example of a crown shell that can be used to form a dental crown on a tooth of a particular shape.

FIG. 2 illustrates another example of a crown shell that can be used to form a dental crown on a tooth with a different shape.

FIG. 3A illustrates an example of a dental crown installed on a tooth.

FIG. 3B illustrates another example of a dental crown installed on a tooth.

FIGS. 4A-4F illustrate exemplary steps for preparing and installing a dental crown on a tooth.

### DETAILED DESCRIPTION

Various illustrations are provided to give a more thorough understanding of the various principles of the embodiments of the present disclosure. The following description is exemplary in nature and is not intended to limit the scope, applicability, or configuration of the invention in any way. Various changes to the described embodiment may be made in the function and arrangement of the elements described herein without departing from the scope of the invention.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

Moreover, for the sake of simplicity, the attached figures may not show the various ways (readily discernable, based on this disclosure, by one of ordinary skill in the art) in which the disclosed system, method, and apparatus can be used in combination with other systems, methods, and apparatuses. Additionally, the description sometimes uses terms such as “produce” and “provide” to describe the disclosed method. These terms are high-level abstractions of the actual operations that can be performed. The actual operations that correspond to these terms can vary depending on the particular implementation and are, based on this disclosure, readily discernible by one of ordinary skill in the art.

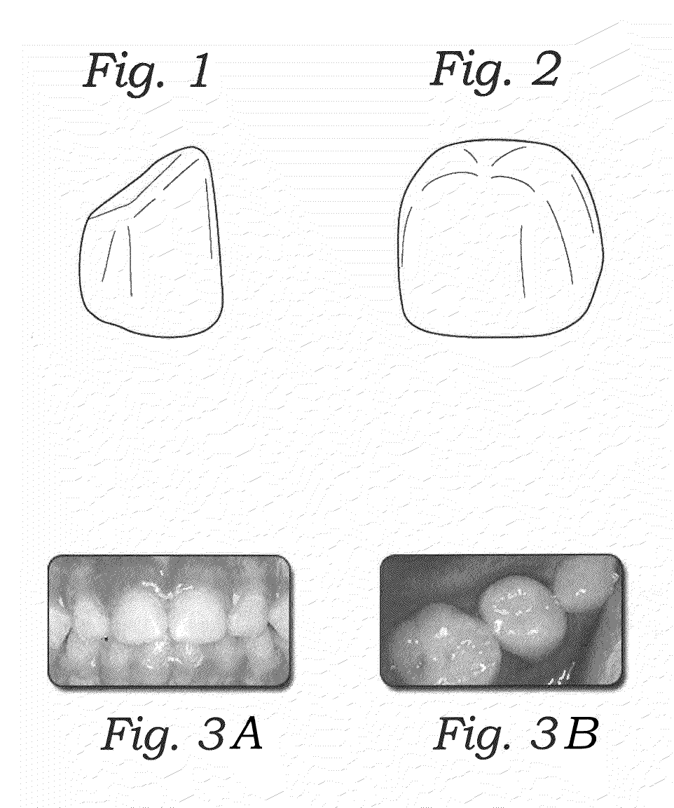

The crown shell is a very thin, anatomically correct polycarbonate crown that is used to create a full crown restoration in the primary dentition. An anatomically correct crown form exists for each of the primary maxillary teeth and for each of the primary mandibular posterior teeth. Examples of the crown shells are shown in FIGS. 1 and 2.

The crown shell can be made of a resinous material, such as a polycarbonate material, for example MAKROLON 2458, which is a bisphenol A polycarbonate thermoplastic polymer. Further information about MAKROLON 2458 can be found in the attached material safety data sheet for the product, which is incorporated by reference. The shell has a closed upper face and side walls, but the bottom face of the shell is open and sufficiently large to fit over a prepared tooth. The walls of the shell are preferably very thin, for example having a maximum thickness of about 0.0015 inches or less, for example a thickness of 0.0013 inches. The very thin walls of the shells are more affected by heat, and therefore are more susceptible to bonding to a resin within the shell when an exothermic reaction occurs. Moreover, by forming the crown shell with very thin walls, the crown shell can be flexible. The flexibility of the crown shell allows for easier positioning of the crown shell on the tooth, which results in a better fit on the tooth.

The crown shells provide aesthetically pleasing results when used to prepare a crown for a pediatric patient. Examples of the installed crowns in a pediatric patient are shown in FIGS. 3A and 3B. As shown in FIGS. 3A and 3B, the installed crowns are substantially transparent and shaped with an exterior surface that is generally anatomically correct, making it very difficult to discern the presence of the installed crowns on the teeth.

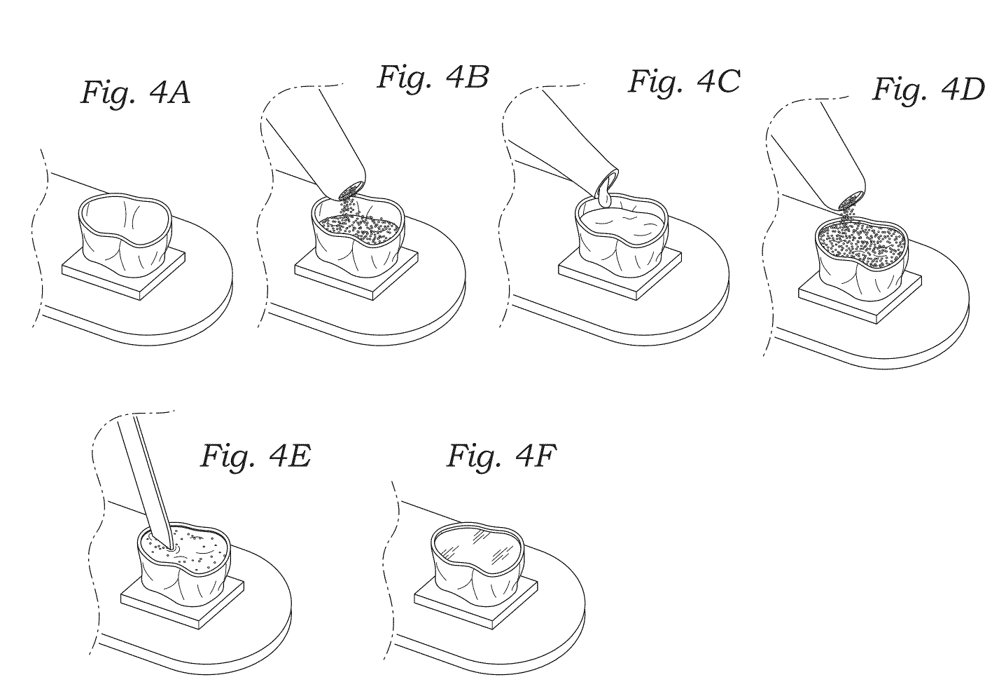

FIGS. 4A-4F illustrate a method of preparing a crown shell for placement on a tooth. The crown shell is prepared as shown in FIG. 4A by inverting the shell so that the open bottom face points upwardly. An adhesive powder is then placed in the shell, for example partially filling it to half its height as shown in FIG. 4B. An adhesive liquid is then introduced into the powder in the shell until the powder is saturated with the adhesive liquid as shown in FIG. 4C. Additional powder is then added to the shell until the shell is filled to its brim as shown in FIG. 4D. The acrylic is next mixed in situ in the shell, for example using a spatula (FIG. 4E), to promote polymerization until the acrylic begins to thicken as polymethyl methacrylate acrylic plastic forms (FIG. 4F).

The acrylic-filled crown shell with the partially thickened polymer is then seated on the prepared tooth by introducing the prepared tooth through the open face of the shell. Once seated on the prepared tooth, the acrylic is allowed to cure until initial setting has taken place and an internal cavity is formed within the shell that has a shape complementary to the prepared tooth. The crown is then removed from the prepared tooth with a crown removal instrument to be finished and polished. The crown is next placed back in the mouth with the complementary shape in the acrylic fitting over the prepared tooth. A cement, such as a glass ionomer cement, is provided between the prepared tooth and the cured acrylic to secure the crown to the prepared tooth.

If desired, a kit that contains a box for the multiple crown shells, and separate bottles that contain the powder and liquid to prepare the resin, can be provided.

The acrylic filler is preferably a material that undergoes an exothermic reaction when the powder is mixed with the liquid in the shell. Without wishing to be bound by theory, it is believed that the in situ exothermic reaction bonds the acrylic to the shell in a manner that avoids fracturing and breaking of the shell under normal occlusion as has often occurred with plastic pediatric crown shells in the past.

An example of a suitable acrylic adhesive powder is a lower alkyl methacrylate (monomer) powder, such as methyl methacrylate (monomer) powder, such as F-88 adhesive powder available from American Consolidated Manufacturing Co, Inc. The powder is further described in the attached material safety data sheet 8040-00-996-9017 which is incorporated by reference.

An example of a suitable adhesive liquid to mix with the acrylic powder is F-88 adhesive lower alkyl methacrylate (monomer) powder, such as methyl methacrylate (monomer) powder, such as F-88 adhesive liquid available from American Consolidated Manufacturing Co, Inc. that also contains an inhibitor and promoter to induce polymerization of the methyl in the crown shell. The powder is further described in the attached material safety data sheet 8040-00F008065 which is incorporated by reference.

The F-88 adhesive powder and liquid mixture is particularly desirable because the strength of the bond will not vary greatly across different mix ratios. Thus, for example, regardless of the ratio of powder to liquid, a tensile shear strength of a cured mixture of the F-88 adhesive powder and liquid can be about 1500 psi or greater. Thus, the use of F-88 adhesive powder and liquid mixture can eliminate or greatly reduce the need for accurately or precisely measured ratios of adhesive liquids and powders.

As noted above, the ratio of adhesive powder to adhesive liquid can vary. Generally, an increase in the relative amount of liquid will increase the curing time. For example, with a ratio of about 4:1 powder to liquid by volume, the curing time can be about five minutes. As this ratio increases, the curing time will generally increase. Thus, for example, a ratio of about 3:1 can have a curing time of about twelve minutes, a ratio of about 2:1 can have a curing time of about fifteen minutes, and a ratio of about 3:2 can have a curing time of about twenty-five minutes. Thus, the ratio of adhesive powder to liquid can vary depending on the amount of curing time desired by the user.

A glass ionomer cement is a dental restorative material, based on the reaction of silicate glass powder and polyalkenoic acid to produce a tooth colored material.

The resulting pediatric crown is an aesthetically pleasing and cost-effective full crown alternative to the unsightly stainless steel crown, the bulky composite veneered stainless steel crown, or the conventional composite strip crown.

This disclosed pediatric crown provides long-term success, strength and durability similar to stainless steel crowns while providing excellent aesthetic full coverage restorations for both posterior and anterior primary teeth, without the typical problems of:
unsightly metal;
bulky composite coated stainless steel crowns that require over preparation and are difficult to adapt;
composite facings and veneers that eventually chip off; and
anterior composite strip crowns that can have short lasting aesthetics.

A method is also disclosed for using the crown to provide an ultra-thin crown that is anatomically correct, flexible, easy to fit, and very strong and durable.

Because of the strength and durability of the crown shells described herein, they can be particularly useful with pediatric patients, where the expected life of a crown is generally less than about eight years, and, usually, less than about five years. However, it should be understood that the crown shells described herein can also generally be used with adults, especially as a temporary restoration member for use prior to fitting the patient with a permanent crown.

When used in combination with a simple acrylic fill technique and glass ionomer cementation procedure, the result is an exceptional and cost-effective full coverage restoration that provides superior marginal integrity, excellent retention, durability, high tensile strength, and very natural looking aesthetics. The device and method are suitable for both posterior and anterior dental restorations.

According to one embodiment of the present invention, a shell or a set of shells is provided for fabricating pediatric dental crowns. Sets of shells can include shells configured to replicate different tooth sizes and shapes. Kits containing different size shells can also be provided to more accurately match shells to different size teeth.

Each shell preferably includes mesial, distal, buccal, lingual, and occlusal walls. The occlusal surface can be contoured to replicate the occlusal surface of a natural tooth.

The gingival margin of the shell is preferably shaped to match the gingival area of the prepared tooth. More specifically, the shape of the mesial, distal, buccal, and lingual sidewalls and the length thereof can best be described using a 3 dimensional plane: the buccal-lingual dimension, the mesial-distal dimension, and the occlusal-gingival dimension. The shape and length of the shell and sidewalls can vary depending on the specific tooth that has been prepared for a crown, i.e., a lower right molar shell can be selected for a lower right molar and an upper left bicuspid shell can be selected for an upper left bicuspid. The margin of the sidewalls preferably mimics the shape of the gingival area surrounding the prepared tooth, so that these edges substantially conform to that surrounding gingival tissue.

The most common method of preparing a tooth for a full coverage crown is to prepare or grind the tooth in approximately a 5 degree taper down to about the cemento-enamel junction or CEJ of the tooth. The CEJ is an area of the tooth close to the gingival tissue where the enamel stops and the cementum covered root starts

The mesial, distal, buccal, and lingual sidewalls preferably mimic the prepared tooth both in shape and length using the CEJ as a reference point for the gingival margin of the shell. The shell preferably fits passively over the prepared tooth with a very accurate fit at the CEJ. The purpose of the shell mimicking a natural tooth at the CEJ and tapering similarly to a prepared tooth is to control the flow of excess resin liner and obtain a very accurate fit without trimming the shell and with very little excess resin to grind and finish.

In a most preferred configuration of the embodiments disclosed herein, there are no windows provided in the mesial or distal sidewalls, and there are also preferably no recessed areas or concavities arranged along the mesial and distal sidewalls.

In view of the many possible embodiments to which the principles of our invention may be applied, it should be recognized that the illustrated embodiment is only a preferred example of the invention and should not be taken as a limitation on the scope of the invention. Rather, the scope of the invention is defined by the following claims. We therefore claim as our invention all that comes within the scope and spirit of these claims.

We claim:

1. A method of making a dental crown for a tooth, the method comprising:
providing a flexible crown shell formed of a resinous material and having a thickness of about 0.0015 inches or less, the crown shell having a closed upper face, closed side walls, and an open bottom face;
inverting the crown shell so that the open bottom face is directed upwardly;
introducing a mixture of an adhesive powder and an adhesive liquid into the crown shell through the open bottom face;
positioning the crown shell onto a tooth by introducing the tooth through the open bottom face of the crown shell;
allowing the mixture to cure until an internal cavity is formed within the shell with a shape that is substantially complementary to the tooth;
removing the crown shell from the tooth;
providing a cement between the tooth and the cured mixture; and
securing the crown shell to the tooth,
wherein the introduction of the mixture into the crown shell causes an exothermic reaction that bonds the mixture to an interior surface of the crown shell.

2. The method of claim 1, wherein the crown shell has a thickness of about 0.0013 inches or less.

3. The method of claim 1, wherein the introduction of the mixture comprises:
introducing the adhesive powder into the crown shell through the open bottom face;
introducing the adhesive liquid into the crown shell through the open bottom face to saturate the adhesive powder;
adding additional adhesive powder to substantially fill the crown shell; and
mixing the adhesive powder and adhesive liquid in the crown shell to produce the mixture.

4. The method of claim 1, wherein the crown shell comprises a polycarbonate material, the adhesive powder and adhesive liquid comprise methyl methacrylate.

5. The method of claim 4, wherein the adhesive powder comprises F-88 adhesive powder and the adhesive liquid comprises F-88 adhesive liquid.

6. The method of claim 1, wherein the tooth comprises a tooth of a pediatric patient and the securing of the crown shell to the tooth is permanent.

7. A kit for preparing a dental crown for a tooth, the kit comprising:
a flexible shell formed of a resinous material and having a thickness of about 0.0015 inches or less, the flexible shell having a closed upper face, closed side walls, and an open bottom face; and
an adhesive powder and an adhesive liquid that can be mixed together to cause an exothermic reaction sufficient to bond the mixture of the adhesive powder and adhesive liquid to an interior surface of the flexible shell.

8. The kit of claim 7, wherein the flexible shell has a thickness of about 0.0013 inches or less.

9. The kit of claim 7, wherein the flexible shell comprises bisphenol A polycarbonate.

10. The kit of claim 9, wherein the flexible shell is generally translucent.

11. The kit of claim 7, wherein the adhesive powder and adhesive liquid comprise methyl methacrylate.

12. The kit of claim 11, wherein the adhesive powder comprises F-88 adhesive powder and the adhesive liquid comprises F-88 adhesive liquid.

13. The kit of claim 7, wherein a mixture of the adhesive powder and the adhesive liquid comprises a tensile shear strength of about 1500 psi or greater when cured.

14. The kit of claim 7, further comprising a plurality of flexible shells of different shapes and sizes.

15. The kit of claim 14, wherein the plurality of flexible shells are configured to substantially anatomically match the exterior shape of teeth.

16. A dental crown comprising:
a generally translucent, flexible shell formed of a resinous material and having a thickness of about 0.0015 inches or less,
wherein the flexible shell has a closed upper face, closed side walls, and an open bottom face, and the open bottom face is sized to receive a tooth and the exterior shape of the closed upper face and side walls are substantially shaped to match the exterior shape of a tooth.

17. The crown of claim 16, wherein the flexible shell has a thickness of about 0.0013 inches or less.

18. The crown of claim 17, wherein the flexible shell comprises bisphenol A polycarbonate.
